(19) United States
(12) Patent Application Publication
(10) Pub. No.: US 2025/0292312 A1
(43) Pub. Date: Sep. 18, 2025

(54) SMART MERCHANDISE BRANDING

(71) Applicant: eBay Inc., San Jose, CA (US)

(72) Inventors: Ryan Christopher WONG, San Jose, CA (US); Lavanya LINGAM, San Jose, CA (US); Yuxin ZHAO, San Jose, CA (US); Nicholas Hart DIERAUF, San Jose, CA (US); Julie Anne SAKALYS, San Jose, CA (US); Biao LUO, San Jose, CA (US); Deepak T. BELLIMAGGA, San Jose, CA (US); Aroop PATTANAIK, San Jose, CA (US); Vinaya KHIRE, San Jose, CA (US); Usha ACHLADI, San Jose, CA (US); Jian PAN, San Jose, CA (US); Shyam ERANKY, San Jose, CA (US)

(21) Appl. No.: 18/605,098

(22) Filed: Mar. 14, 2024

(51) Int. Cl. G06Q 30/0601; G06Q 30/0201; G06Q 30/08

(52) U.S. Cl. CPC G06Q 30/0643; G06Q 30/0201; G06Q 30/08

(57) ABSTRACT

Smart merchandise branding is provided by automatically activating and populating smart strips in a store management platform. Initially, active sellers in the store management platform are identified. A seller of the active sellers is determined to be eligible for smart strips (e.g., a designated portion of the electronic storefront corresponding to the seller that highlights particular items the seller has listed for sale). The smart strips are automatically populated on the electronic storefront with data. In various aspects, the smart strips correspond to auctions ending soon, featured categories, and/or newly listed items.

### BACKGROUND

Store management systems enable sellers to list a variety of different items for sale in a variety of different formats. For example, a seller may list an item for sale in an auction that has an ending date. The seller may additionally list an item for sale that can be categorized as a collectible. Each item the seller lists may be viewable by buyers within an electronic storefront (i.e., an individual and customizable web page corresponding to the seller within the store management system). For a seller with a large number of items for sale and an available inventory that is constantly changing, it is impracticable and resource-intensive for a seller to update the storefront in a way that aligns with a particular branding strategy (e.g., highlighting a particular category of items, highlighting auction items with an ending date approaching, highlighting newly listed items, etc.).

### SUMMARY

Various aspects of the technology described herein are generally directed to systems, methods, and computer storage media for, among other things, providing smart merchandise branding. More particularly, aspects of the technology describe herein automatically activate and populate smart strips in a store management platform. Initially, active sellers in a store management platform are identified. Next, a seller of the active sellers is determined to be eligible for smart strips (e.g., a designated portion of the electronic storefront corresponding to the seller that highlights particular items the seller has listed for sale). The smart strips are automatically populated on the electronic storefront with data. In various aspects, the smart strips correspond to auctions ending soon, featured categories, and/or newly listed items.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIG. 1 provides a block diagram of an exemplary store management system computing environment suitable for use in implementing aspects of the technology described herein;

FIG. 2 provides an example method of activating smart strips in a store management system, in accordance with aspects of the technology described herein;

FIG. 3 provides an example method of populating ending soonest smart strips in a store management system, in accordance with aspects of the technology described herein;

FIG. 4 provides an example method of populating featured categories smart strips in a store management system, in accordance with aspects of the technology described herein;

FIG. 5 provides an example method of populating newly listed smart strips in a store management system, in accordance with aspects of the technology described herein;

FIG. 6 provides an example user interface illustrating ending soonest smart strips in a store management system, in accordance with aspects of the technology described herein;

FIG. 7 provides an example user interface illustrating featured categories smart strips in a store management system, in accordance with aspects of the technology described herein;

FIG. 8 provides an example user interface illustrating newly listed smart strips in a store management system, in accordance with aspects of the technology described herein; and

FIG. 9 is a block diagram of an exemplary computing environment suitable for use in implementing aspects of the technology described herein.

### DETAILED DESCRIPTION OF THE INVENTION

A store management system supports storing items (products or assets) in item databases and providing a search system for receiving queries and identifying search result items based on the queries. An item (e.g., physical item or digital item) refers to a product or asset that is provided for listing on a store management platform. Search systems support identifying, for received queries, result items from item databases. Item databases can specifically be for content platform or store management platforms such as EBAY content platform, developed by EBAY INC., of San Jose, California.

Conventionally, store management systems are not configured with a comprehensive logic and infrastructure to effectively provide automated storefront management of a store management system. Instead, store management systems rely on manual updates by individual sellers to manage what items are highlighted by the seller. For a seller with a large number of items for sale and an available inventory that is constantly changing, it is impracticable and resource-intensive for a seller to update the storefront in a way that aligns with a particular branding strategy (e.g., highlighting a particular category of items, highlighting auction items with an ending date approaching, highlighting newly listed items, etc.). As a result, sellers miss opportunities to attract buyers. Moreover, a potential buyer cannot reasonably identify a particular item listed by a particular seller without exhausting unnecessary computing resources and the potential buyer may leave the seller's storefront without ever finding the particular item.

This requires users to perform multiple searches to find particular items listed by a particular seller, such as an item in a particular category, an item listed in an auction with an ending date approaching, or a newly listed item. This process unnecessarily consumes various computing resources of the store management system, such as processing power, network bandwidth, throughput, memory consumption, etc. In some instances, the multiple attempts to find particular items may even completely fail to satisfy the user's goal, thus requiring the user to spend even more time and computing resources on the search process by repeating the process of issuing additional queries until the user finally accesses the desired content items. In some cases, the user may even give up searching because the search engine was not able to return desired search results after multiple searches.

These shortcomings of existing store management systems adversely affect computer network communications. For example, each time a query is received, contents or payload of the search queries is typically supplemented with header information or other metadata, which is multiplied by all the additional queries needed to obtain the particular items the user desires to complete a task. As such, there are throughput and latency costs by repetitively generating this metadata and sending it over a computer network. In some instances, these repetitive inputs (e.g., repetitive clicks, selections, or queries) increase storage device I/O (e.g., excess physical read/write head movements on non-volatile disk) because each time a user inputs unnecessary information, such as inputting several queries, the computing system often has to reach out to the storage device to perform a read or write operation, which is time consuming, error prone, and can eventually wear on components, such as a read/write head. Further, if multiple users repetitively issue queries, it is expensive because processing queries consumes a lot of computing resources. For example, for some search engines, a query execution plan may need to be calculated each time a query is issued, which requires a search system to find the least expensive query execution plan to fully execute the query. This decreases throughput and increases network latency, and can waste valuable time.

Aspects of the technology described herein improve the functioning of the computer itself in light of these shortcomings in existing store management systems by providing a solution that enables a store management system to automatically activate and populate smart strips on the storefront of eligible sellers, enabling a buyer to quickly identify particular items listed by a particular seller, such as an item in a particular category, an item listed in an auction with an ending date approaching, or a newly listed item. As can be appreciated, better results are achieved compared to traditional store management systems that require multiple search queries from the user.

Aspects of the technology described herein provide a number of improvements over existing store management systems. For instance, computing resource consumption is improved relative to existing technologies. In particular, the storefronts of sellers (and the limited real estate provided within the seller page) is enhanced by automatically activating and populating smart strips on the storefront of an eligible seller, thereby allowing the user to more quickly access relevant search results. This eliminates (or at least reduces) the repetitive user queries and filter selections because the smart strips comprise particular items listed by a particular seller, such as an item in a particular category, an item listed in an auction with an ending date approaching, or a newly listed item. Accordingly, aspects of the technology described herein decrease computing resource consumption, such as processing power and network bandwidth. For instance, a user query (e.g., an HTTP request), would only need to traverse a computer network once (or fewer times relative to existing technologies).

In like manner, aspects of the technology described herein improve storage device or disk I/O and query execution functionality. As described above, the inability to automatically highlight particular items listed by a particular seller in existing store management systems results in repetitive user queries and filter selections. This causes multiple traversals to disk I/O. In contrast, aspects described herein reduce storage device I/O because the user provides a reduced amount of inputs so the computing system does not have to reach out to the storage device as often to perform a read or write operation. For example, by automatically activating and populating smart strips on the storefront of eligible sellers, a buyer is able to quickly identify particular items listed by a particular seller, such as an item in a particular category, an item listed in an auction with an ending date approaching, or a newly listed item. Accordingly, there is not as much wear due to query execution functionality.

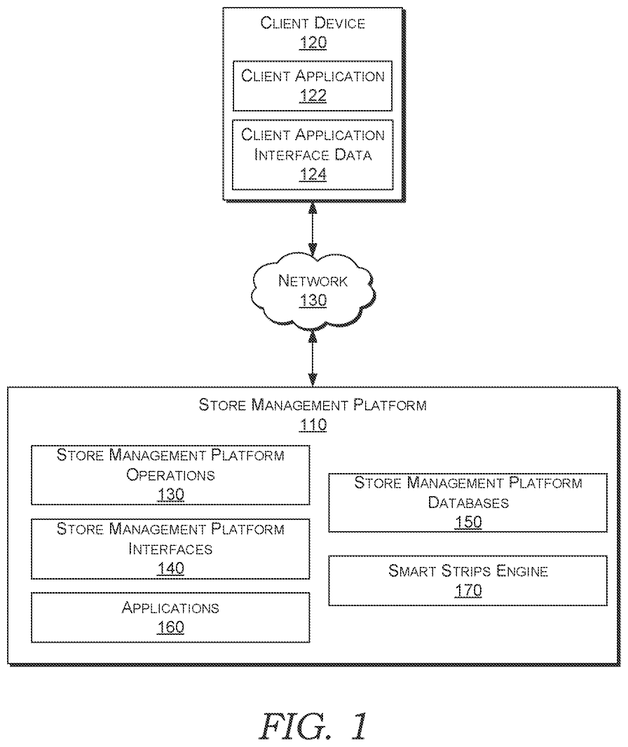

Referring now to FIG. 1, FIG. 1 illustrates an example store management system 100 computing environment in which implementations of the present disclosure may be employed. In particular, FIG. 1 shows a high level architecture of an example store management platform 110 that can host a technical solution environment, or a portion thereof. It should be understood that this and other arrangements described herein are set forth as examples. For example, as described above, many elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The store management platform 100 can be a cloud computing environment that provides computing resources for functionality associated with the store management platform 110. For example, the store management system 100 supports delivery of computing components and services-including servers, storage, databases, networking, and applications associated with the store management platform 110 and client device 120. A plurality of client devices (e.g., client device 120) include hardware or software that access resources on the store management system 100. Client device 120 can include an application (e.g., client application 122) and interface data (e.g., client application interface data 124) that support client-side functionality associated with the store management system. The plurality of client devices can access computing components of the store management system 100 via a network (e.g., network 130) to perform computing operations.

The store management platform 110 is responsible for providing a computing environment or architecture that includes the infrastructure that supports providing store management platform functionality (e.g., e-commerce functionality). The store management platform support storing item in item databases and providing a search system for receiving queries and identifying search results based on the queries. The store management platform may also provide a computing environment with features for managing, selling, buying, and recommending different types of items. Store management platform 110 can specifically be for a content platform such as EBAY content platform or e-commerce platform, developed by EBAY INC., of San Jose, California.

The store management platform 110 can provide item listing operations 130 and item listing interfaces 140. The item listing operations 130 can include service operations, communication operations, resource management operations, security operations, and fault tolerance operations that support specific tasks or functions in the store management platform 110. The item listing interfaces 140 can include service interfaces, communication interfaces, resource interfaces, security interfaces, and management and monitoring interfaces that support functionality between the store management platform components. The item listing operations 130 and item listing interfaces 140 can enable communication, coordination and seamless functioning of the store management system 100.

By way of example, functionality associated with store management platform 110 can include shopping operations (e.g., product search and browsing, product selection and shopping cart, checkout and payment, and order tracking); user account operations (e.g., user registration and authentication, and user profiles); seller and product management operations (e.g., seller registration and product listing and inventory management); payment and financial operations (e.g., payment processing, refunds and returns); order fulfillment operations (e.g., order processing and fulfillment and inventory management); customer support and communication interfaces (e.g., customer support chat/email and notifications); security and privacy interfaces (e.g., authentication and authorization, payment security); recommendation and personalization interfaces (e.g., product recommendations and customer reviews and ratings); analytics and report interfaces (e.g., sales and inventory reports, and user behavior analytics); and APIs and Integration Interfaces (e.g., APIs for Third-Party Integration).

The store management platform 110 can provide store management platform databases (e.g., store management platform databases 150) to manage and store different types of data efficiently. The store management platform databases 150 can include relational databases, NoSQL databases, search databases, cache databases, content management systems, analytics databases, payment gateway database, customer relationship management databases, log and error databases, inventory and supply chain databases, and multi-channel databases that are used in combination to efficiently manage data and provide e-commerce experience for users.

The store management platform 110 supports applications (e.g., applications 160) that is a computer program or software component or service that serves a specific function or set of functions to fulfil a particular store management platform requirement or user requirement. Applications can be client-side (user-facing) and server-side (backend). By way of example, applications can include an online storefront application, mobile shopping app, admin and management console, payment gateway integration, user account and authentication application, search and personalization engines, inventory and stock management application, order processing and fulfillment application, customer support and communication tools, content management system, analytics and report applications, marketing and promotion applications, multi-channel integration applications, log and error tracking applications, customer relationship management (CRM) applications, security applications, and APIs and web services that are used in combination to efficiently deliver e-commerce experiences for users.

The items listing platform 110 can include a smart strips engine 170. In aspects, the smart strips engine 170 automatically activates and populates smart strips within the storefront of eligible sellers (i.e., an individual and customizable web page corresponding to the seller within the store management system). To do so, the smart strips engine 170 analyzes data and issues a number of API calls, such as to store management platform databases 150.

Initially, the smart strips engine 170 identifies active sellers within the store management platform 110. An active seller may be a user who has listed an item for sale within a particular threshold of time, a user who currently has an item listed for sale, a user who has logged into the store management platform 110 with a particular threshold of time, and the like. The smart strips engine 170 determines, via an API call, a seller of the active sellers that is eligible for smart strips. After eligibility is determined, the smart strips engine 170 enables the smart strips on an electronic storefront of the store management system for the eligible seller. Once enabled, the smart strips engine 170 automatically populates the smart strips on the electronic storefront of the seller with data, which may also be retrieved by the smart strips engine 170 via an API call.

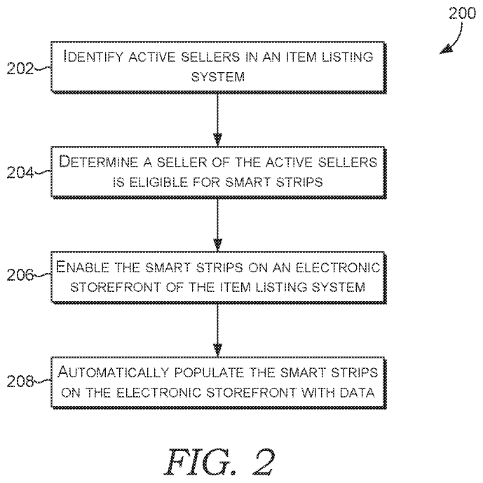

With reference to FIGS. 2, 3, 4, and 5, flow diagrams that illustrate example methods for activating and/or populating smart strips, in various aspects, are provided. The methods may be performed using the store management system described herein. In embodiments, one or more computer-storage media having computer-executable or computer-useable instructions embodied thereon that, when executed, by one or more processors can cause the one or more processors to perform the methods (e.g., computer implemented method) in a store management system (e.g., computerized system or computer system).

Turning to FIG. 2, a flow diagram is provided that illustrates an example method 200 for activating smart strips in a store management system, in accordance with aspects of the technology described herein. At block 202, active sellers in a store management system are identified. At block 204, eligibility for smart strips of a seller of the active sellers is determined. At block 206, the smart strips are enabled on an electronic storefront of the store management system for the eligible seller. At block 208, the smart strips are automatically populated on the electronic storefront with data. The data may include, in various aspects and as described below, auctions ending soonest, newly listed items, and/or featured categories.

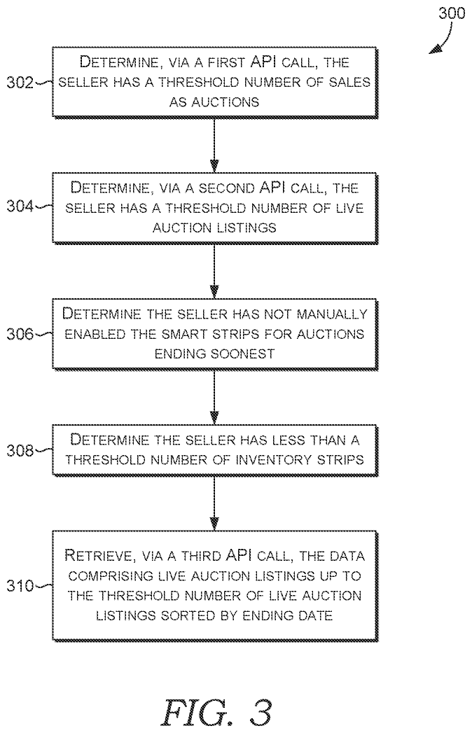

Turning to FIG. 3, a flow diagram is provided that illustrates an example method 300 for populating ending soonest smart strips in a store management system, in accordance with aspects of the technology described herein. At block 302, an API call is made to determine if the seller has a threshold number of sales as auctions (e.g., at least 25% of sales in last 90 days). At block 304, an API call is made to determine if the seller has a threshold number of live auction listings (e.g., at least 4 auction listings currently live). At block 306, it is determined the seller has not manually enabled the smart strips for auctions ending soonest. At block 308, it is determined the seller has less than a threshold number of inventory strips (e.g., 4). For clarify, an inventory strip is similar to a smart strip but has been manually created by the seller and does not correspond to auctions ending soonest, featured categories, or newly listed items. At block 310, an API call is made to retrieve the data comprising live auction listings up to the threshold number of live auction listings sorted by ending date.

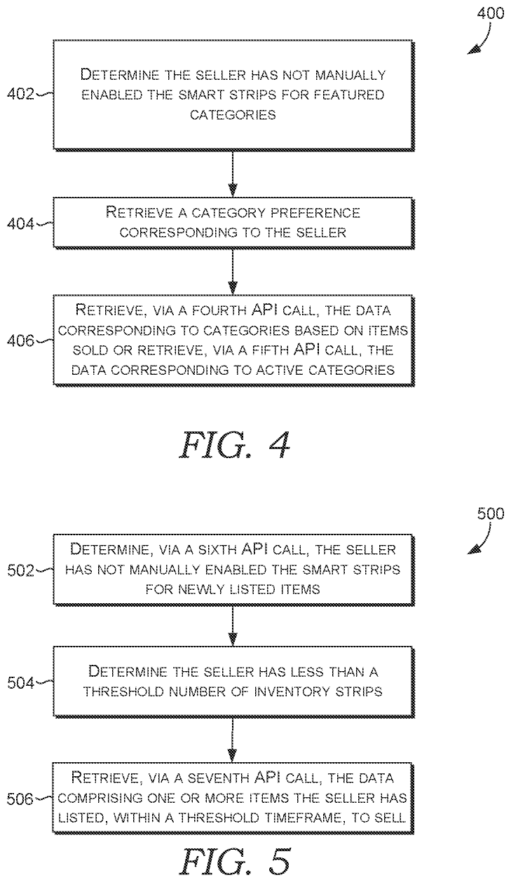

Turning to FIG. 4, a flow diagram is provided that illustrates a method 400 for populating featured categories smart strips in a store management system, in accordance with aspects of the technology described herein. At block 402, it is determined the seller has not manually enabled the smart strips for featured categories. At block 404, a category preference corresponding to the seller is retrieved. In aspects, the category preference may be based on the store management platform categories or based on seller defined categories. If the preference is the store management platform categories, the top categories may be retrieved based on items sold by the seller. If there is no items sold data available, the top categories are retrieved based on the number of listings the seller has for each category. At block 406, an API call is made to retrieve the data corresponding to categories based on items sold or to retrieve the data corresponding to active categories. In some aspects, an image from a listing in each of the top categories is added to the smart strip.

Turning to FIG. 5, a flow diagram is provided that illustrates a method 500 for populating newly listed items smart strips in a store management system, in accordance with aspects of the technology described herein. At block 502, an API call is made to determine the seller has not manually enabled the smart strips for newly listed items. At block 504, it is determined the seller has less than a threshold number of inventor strips. In some aspects, only four items may be displayed by the newly listed smart strips. At block 506, an API call is made to retrieve the data comprising one or more items the seller has listed, within a threshold timeframe, to sell. Accordingly, as items are listed by the seller, the oldest listed items in the smart strips may be removed and replaced by the more recently listed items.

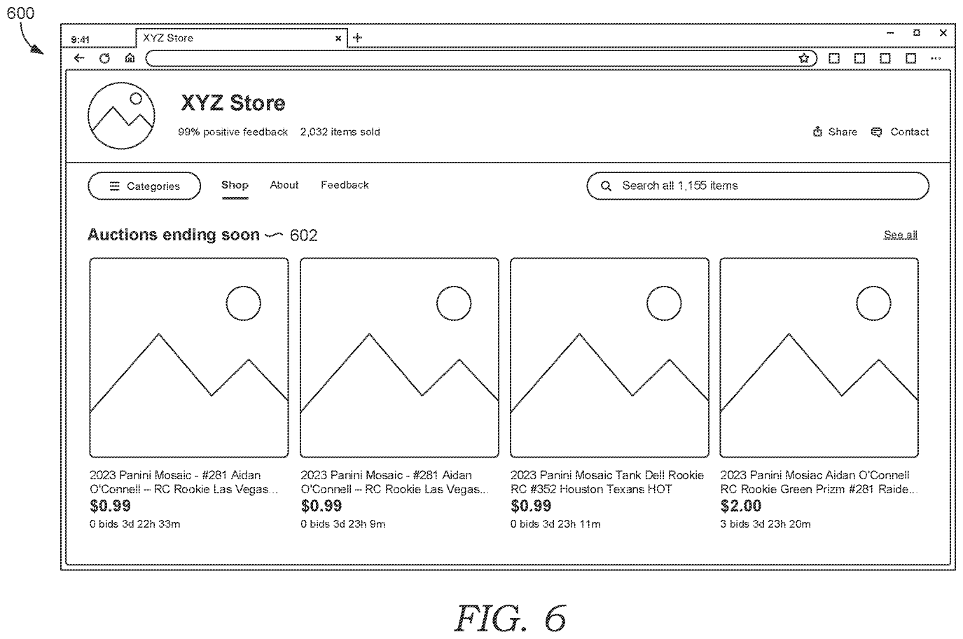

In practice, and turning now to FIGS. 6-8, example user interfaces 600, 700, 800 illustrate various smart strips. For example, FIG. 6 is an example user interface 600 illustrating ending soonest smart strips in a store management system, in accordance with aspects of the technology described herein. As illustrated, smarts strips for auctions ending soon 602 have been activated and populated on premium real estate of the seller storefront. Based on the available real estate on the seller webpage (or based on a screen size and/or resolution of the device being used to view the seller webpage), a maximum of four smart strips for auction ending soon may be visible. As a particular auction for a smart strip ends, another smart strip may be populated for the auction item ending soonest (if another auction item is listed by the particular seller) that is not yet included in the smart strips.

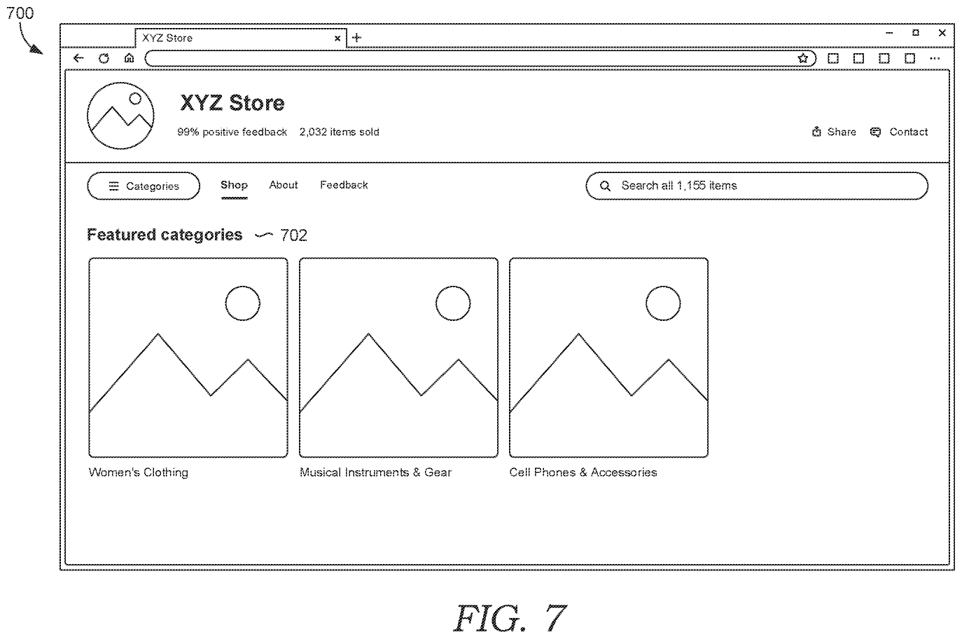

In another example, FIG. 7 is an example user interface 700 illustrating featured categories smart strips in a store management system, in accordance with aspects of the technology described herein. As illustrated, smarts strips for featured categories 702 have been activated and populated on premium real estate of the seller storefront. As with auctions ending soon, a maximum of four smart strips for featured categories may be visible. In this example, three smart strips for features categories are visible.

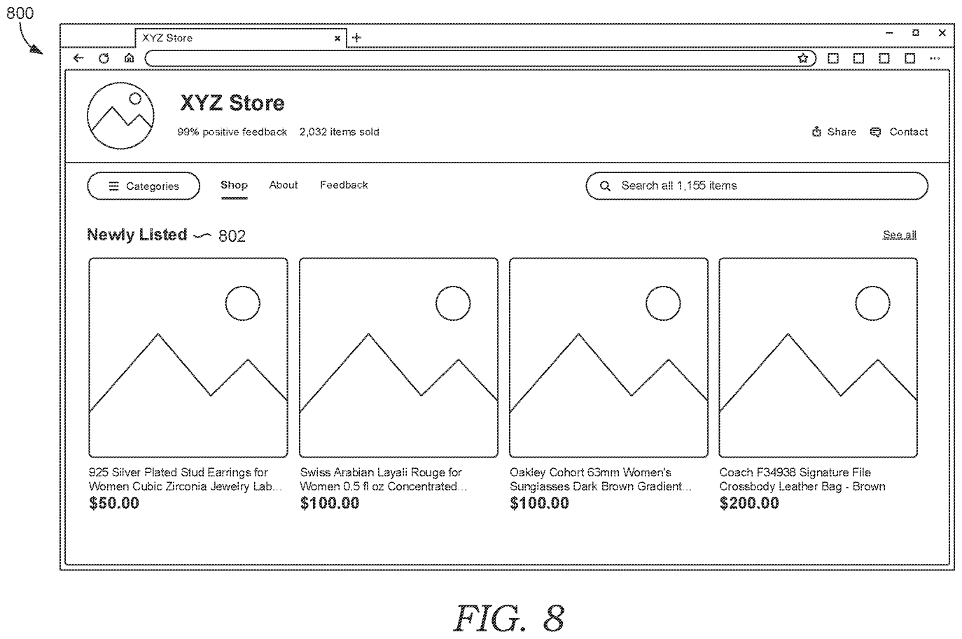

In yet another example, FIG. 8 is an example user interface 800 illustrating newly listed items smart strips in a store management system, in accordance with aspects of the technology described herein. As illustrated, smarts strips for newly listed items 802 have been activated and populated on premium real estate of the seller storefront. As with auctions ending soon and featured categories, a maximum of four smart strips for newly listed items may be visible. As the seller with four smart strips for newly listed items lists additional items, the newest item takes the place of the oldest item currently populating the smart strips.

Embodiments of the present invention have been described with reference to several inventive features (e.g., operations, systems, engines, and components) associated with a store management system. Inventive features described include: operations, interfaces, data structures, and arrangements of computing resources associated with providing the functionality described herein relative with reference to a store management system.

Embodiments of the present invention relate to the field of computing, and more particularly to store management systems. The following described exemplary embodiments provide a system, method, and program product to, among other things, activate and populate smart strips using a smart strips engine. Therefore, the present embodiments have the capacity to improve the technical field of store management system technology by providing more efficient user interfaces (for both sellers and buyers). For example, interfaces described for this technical solution provide a specific improvement over prior systems, resulting in an improved user interface for a store management system. In particular, the particular manner of activating and populating smart strips do not use conventional user interface methods. The technical solution addresses conventional store management platforms' lack of integration with a smart strips engine that improves store management system technology by redesigning a seller's storefront to align with a particular branding strategy and by improving a buyer's efficiency in navigating store management system interfaces.

Functionality of the embodiments of the present invention have further been described, by way of an implementation and anecdotal examples—to demonstrate that the operations for activating and populating smart strips using a smart strips engine in a store management system as a solution to a specific problem in store management platform technology to improve computing operations in store management systems.

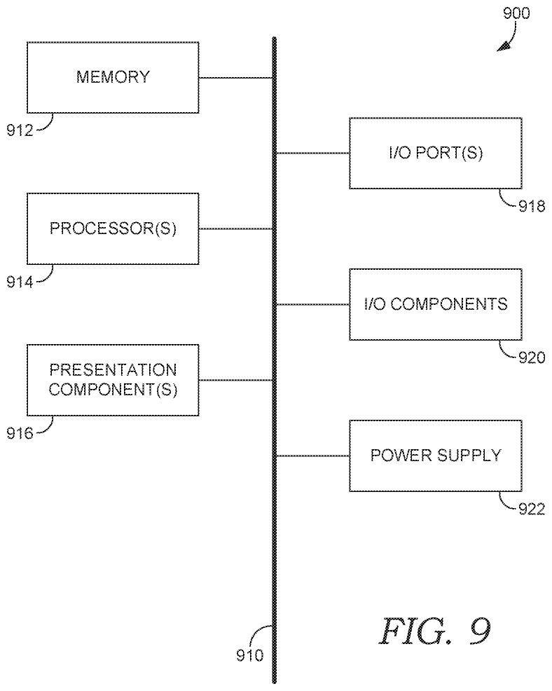

Having briefly described an overview of embodiments of the present invention, an example operating environment in which embodiments of the present invention may be implemented is described below in order to provide a general context for various aspects of the present invention. Referring initially to FIG. 9 in particular, an example operating environment for implementing embodiments of the present invention is shown and designated generally as computing device 900. Computing device 900 is but one example of a suitable computing environment and is not intended to suggest any limitation as to the scope of use or functionality of the invention. Neither should computing device 900 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 9, computing device 900 includes bus 910 that directly or indirectly couples the following devices: memory 912, one or more processors 914, one or more presentation components 916, input/output ports 918, input/output components 920, and illustrative power supply 922. Bus 910 represents what may be one or more buses (such as an address bus, data bus, or combination thereof). The various blocks of FIG. 9 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 9 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 9 and reference to “computing device.”

Computing device 900 typically includes a variety of computer-readable media. Computer-readable media can be any available media that can be accessed by computing device 900 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 900. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 912 includes computer storage media in the form of volatile and/or nonvolatile memory. The memory may be removable, non-removable, or a combination thereof. Exemplary hardware devices include solid-state memory, hard drives, optical-disc drives, etc. Computing device 900 includes one or more processors that read data from various entities such as memory 912 or I/O components 920. Presentation component(s) 916 present data indications to a user or other device. Exemplary presentation components include a display device, speaker, printing component, vibrating component, etc.

I/O ports 918 allow computing device 900 to be logically coupled to other devices including I/O components 920, some of which may be built in. Illustrative components include a microphone, joystick, game pad, satellite dish, scanner, printer, wireless device, etc.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A method of activating and populating smart strips, the method comprising:
identifying active sellers in a store management system;
determining a seller of the active sellers is eligible for smart strips;
enabling the smart strips on an electronic storefront of the store management system corresponding to the seller; and
automatically populating the smart strips on the electronic storefront with data.

2. The method of claim 1, wherein determining the seller of the active sellers is eligible for smart strips comprises:
determining, via a first API call, the seller has a threshold number of sales as auctions;
determining, via a second API call, the seller has a threshold number of live auction listings;
determining the seller has not manually enabled the smart strips for auctions ending soonest; and
determining the seller has less than a threshold number of inventory strips.

3. The method of claim 2, further comprising retrieving, via a third API call, the data comprising live auction listings up to the threshold number of live auction listings sorted by ending date.

4. The method of claim 1, wherein determining the seller of the active sellers is eligible for smart strips comprises determining the seller has manually enabled the smart strips for featured categories.

5. The method of claim 4, further comprising retrieving a category preference corresponding to the seller.

6. The method of claim 5, further comprising:
retrieving, via a fourth API call, the data corresponding to categories based on items sold; or
retrieving, via a fifth API call, the data corresponding to active categories.

7. The method of claim 1, wherein determining the seller of the active sellers is eligible for smart strips comprises determining, via a sixth API call, the seller has not manually enabled the smart strips for newly listed items.

8. The method of claim 7, further comprising retrieving, via a seventh API call, the data comprising one or more items the seller has listed, within a threshold timeframe, to sell.

9. The method of claim 1, wherein determining the seller of the active sellers is eligible for smart strips comprises determining the seller has less than a threshold number of inventory strips.

10. The method of claim 1, wherein determining the seller of the active sellers is eligible for smart strips comprises determining the seller has reached the threshold number of existing smart strips for newly listed items and adds an item to sell.

11. The method of claim 10, further comprising removing the existing smart strips.

12. The method of claim 1, further comprising automatically removing the smart strips from the electronic storefront when the seller is determined to be no longer eligible for smart strips.

13. One or more computer-storage media having computer-executable instructions embodied thereon that, when executed by a computing system having a processor and memory, cause the processor to perform operations, the operations comprising:
identifying active sellers in a store management system;
determining a seller of the active sellers is eligible for smart strips;
enabling the smart strips on an electronic storefront of the store management system corresponding to the seller; and
automatically populating the smart strips on the electronic storefront with data.

14. The media of claim 13, wherein the data corresponds to one or more of: auctions ending soonest, featured categories, or newly listed items.

15. The media of claim 13, wherein the seller of the active sellers is eligible for smart strips if the seller has not manually enabled the smart strips.

16. The media of claim 13, wherein the seller of the active sellers is eligible for smart strips if the seller has less than a threshold number of inventory strips on the electronic storefront.

17. The media of claim 13, further comprising retrieving the data corresponding to the items listed for sale.

18. The media of claim 13, further comprising automatically removing the smart strips from the electronic storefront when the seller is determined to be no longer eligible for smart strips.

19. A computerized system comprising:
one or more computer processors; and
computer memory storing computer-useable instructions that, when used by the one or more computer processors, cause the one or more computer processors to perform operations, the operations comprising:
identifying active sellers in a store management system;
determining a seller of the active sellers is eligible for smart strips;
enabling the smart strips on an electronic storefront of the store management system corresponding to the seller; and
automatically populating the smart strips on the electronic storefront with data.

20. The computerized system of claim 19, further comprising automatically removing the smart strips from the electronic storefront when the seller is determined to be no longer eligible for smart strips.
